(19) United States
(12) Patent Application Publication
(10) Pub. No.: US 2018/0347163 A1
(43) Pub. Date: Dec. 6, 2018

(54) Water-aided Plunger Assembly

(71) Applicant: Kevin Tolman, Ogden, UT (US)

(72) Inventor: Kevin Tolman, Ogden, UT (US)

(21) Appl. No.: 15/995,554

(22) Filed: Jun. 1, 2018

Related U.S. Application Data
(60) Provisional application No. 62/513,487, filed on Jun. 1, 2017.

(51) Int. Cl. E03C 1/306; B08B 9/032; E03C 1/086

(52) U.S. Cl. CPC E03C 1/306; E03C 1/308; E03C 1/086; B08B 9/0322

(57) ABSTRACT

A water-aided plunger assembly for removing plumbing blockages and fixing clogged drains. Once fully assembled the water-aided plunger includes a plunger arm with a hollow channel to facilitate passage of pressurized water therethrough, a plunger head to create a suction force, a tubular house to connect the assembly to a water source, and a faucet adaptor to ensure connection across a wide range of faucets of varied shape and size. The faucet adapter also creates a vacuum seal around the faucet acting as the water source so as to preserve the vacuum and suction force required by the plunger head.

### CROSS REFERENCE TO RELATED APPLICATION

This application claims the benefit of U.S. Provisional Application No. 62/513,487 filed on Jun. 1, 2017. The above identified patent application is herein incorporated by reference in its entirety to provide continuity of disclosure.

### BACKGROUND OF THE INVENTION

The present invention relates to clogged drains. Prolonged and continuous use of a shower, bathroom sink, kitchen sink, or toilet can allow for an accumulation of dirt, hair, bodily fluids, and other refuse in the plumbing used to transport such items out of the house and into the local septic system. In the instances where this accumulation in the plumbing is severe a blockage is formed that prevents passage of wastewater through to the septic system. Removal of such blockages using conventional means can be time consuming, expensive, and potentially damaging to plumbing fixtures. The present invention provides a quick, affordable, and harmless alternative means of removing such blockages from a clogged drain.

Devices have been disclosed in the known art that relate to the removal of clogged drains. These include devices that have been patented and published in patent application publications.

These prior art devices have several known drawbacks. For example, these devices provide no means of connecting a plunger to a water source other than the most commonly used sink faucets, nor do they provide a means of increasing the amount of water pressure provided from that source.

In light of the devices disclosed in the prior art, it is submitted that the present invention substantially diverges in design elements from the prior art and consequently it is clear that there is a need in the art for an improvement to existing clogged drain removal devices. In this regard the instant invention substantially fulfills these needs.

### SUMMARY OF THE INVENTION

In view of the foregoing disadvantages inherent in the known types of clogged drain removal devices now present in the prior art, the present invention provides a new water-aided plunger assembly wherein the same can be utilized for providing convenience for the user when faced with plumbing blockages and clogged drains.

It is therefore an object of the present invention to provide a new and improved drain blockage removal device that has all of the advantages of the prior art and none of the disadvantages.

It is another object of the present invention to provide a faucet adaptor that allows for a plunger to be connected to a wider range of water sources than just the most commonly used sink faucets.

Another object of the present invention is to provide a funnel-shaped faucet adaptor that can increase the amount of water pressure generated by the connected water source.

Yet another object of the present invention is to provide a faucet adaptor that creates a vacuum seal around any faucet head inserted into its body.

A further object of the present invention is to provide a plunger handle through which pressurized water can be directed at drain blockage material while remaining within the confines of the vacuum sealed plunger head.

An additional object of the present invention is to provide a tubular hose connecting the water-aided plunger to a water source, even in instances where the water source is not conveniently located with respect the drain that needs to be unclogged.

Another object of the present invention is to provide an assembly kit for a water-aided plunger that can be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of all elements comprising an embodiment of a water-aided plunger assembly.

FIG. 2 shows an exploded view of a disassembled plunger handle and plunger head from an embodiment of a water-aided plunger assembly.

FIG. 3 shows a cross-sectional view of a disassembled plunger handle and plunger head from an embodiment of a water-aided plunger assembly.

FIG. 4 shows a perspective view of an embodiment of a faucet adaptor from a water-aided plunger assembly.

FIG. 5A shows a cross-sectional view of an embodiment of a faucet adaptor from a water-aided plunger assembly.

FIG. 5B shows a top view of an embodiment of a faucet adaptor from a water-aided plunger assembly.

### DETAILED DESCRIPTION OF THE INVENTION

Reference is made herein to the attached drawings. Like reference numerals are used throughout the drawings to depict like or similar elements of the assembly kit for a water-aided plunger. For the purposes of presenting a brief and clear description of the present invention, the preferred embodiment will be discussed as used for an assembly kit for a water-aided plunger. The figures are intended for representative purposes only and should not be considered to be limiting in any respect.

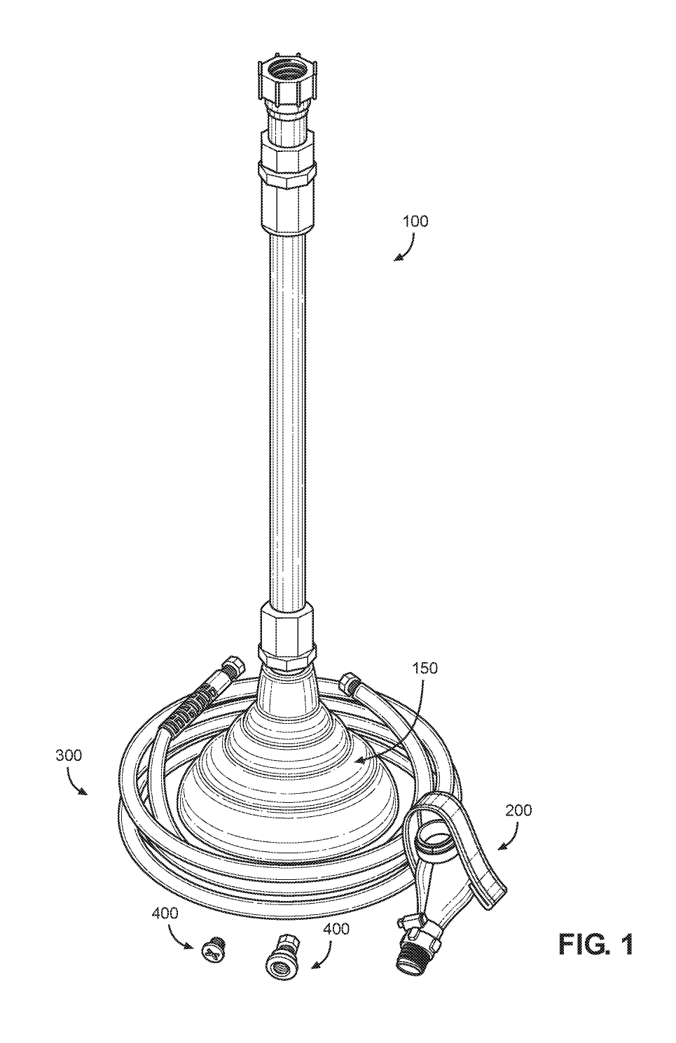

Referring now to FIG. 1, there is shown a perspective view of all elements comprising an embodiment of a water-aided plunger assembly. The water-aided plunger assembly 1000 comprises a plunger handle 100, a plunger head 150, a faucet adapter 200, a tubular hose 300, and a plurality of fixtures 400 to be optionally attached to the hose 300. In the illustrated embodiment, the tubular hose 300 has a first end 310 configured to be removably attached to a faucet adapter 200, and a second end 320 configured to be removably attached to a plunger handle 100.

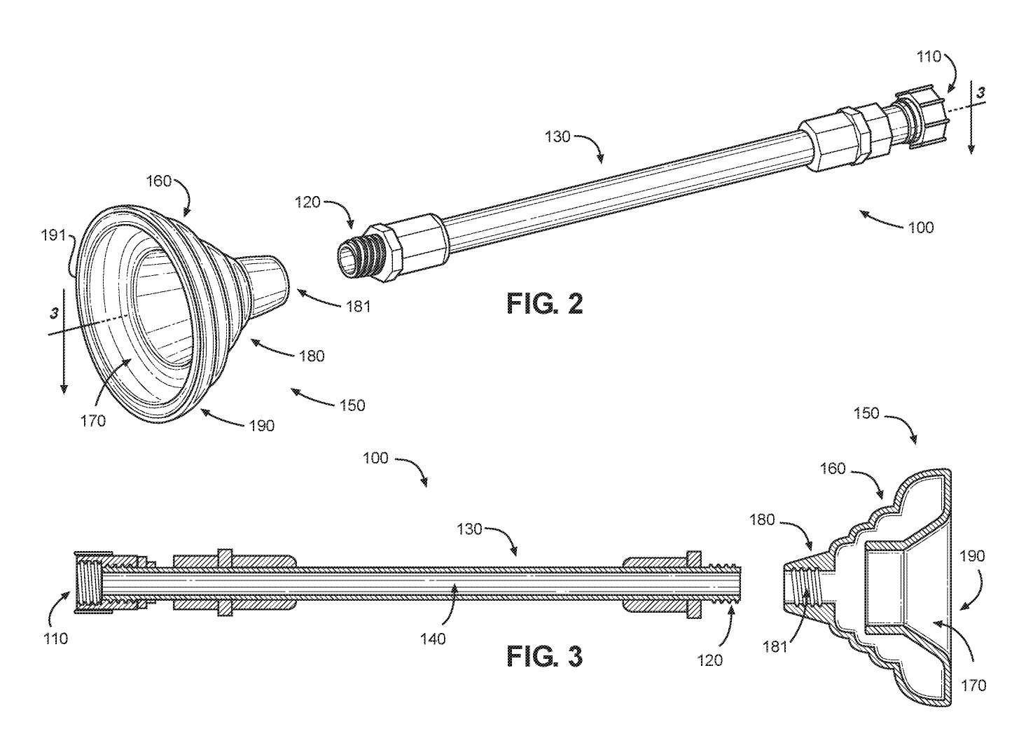

Referring now to FIG. 2, there is shown an exploded view of a disassembled plunger handle and plunger head from an embodiment of a water-aided plunger assembly. In the illustrated embodiment the plunger handle 100 has an elongated rigid cylindrical structure 130 with a first end 110, and a second end 120. The second end 120 is shaped and proportioned to be inserted through a circular aperture 181 disposed on the top end 180 of the plunger head 150, such that the second end 120 of the plunger handle 100 has unimpeded access to the hollow interior cavity 170 of the plunger head 150.

Referring now to FIG. 3, there is shown a cross-sectional view along line 3 of a disassembled plunger handle and plunger head from an embodiment of a water-aided plunger assembly. The surface of the interior wall of the first end 110 of the plunger handle 100 has been shaped and proportioned to receive the second end of the tubular hose. Similarly, the surface of the interior wall of the top end 180 of the plunger head 150 has also has been shaped and proportioned to receive the second end 120 of the plunger handle 100. A channel 140 is disposed between the first end 110 and the second end 120 a to allow pressurized water from the tubular hose 300 to pass through the plunger handle 150 and shoot out from the bottom end 190 of the plunger head.

The dome shaped exterior 160 of the plunger head 150 gradually widens from the narrowest point at the top end 180 down to a circular shaped opening 191 at the bottom end 190, such that when the circular shaped opening 191 is pressed down against a surface a vacuum is created within the hollow interior cavity 170. The combined effect of the vacuum created within the hollow interior cavity 170 and the pressurized water aimed through the plunger handle 150 represents the defining feature of the water-aided plunger assembly 1000.

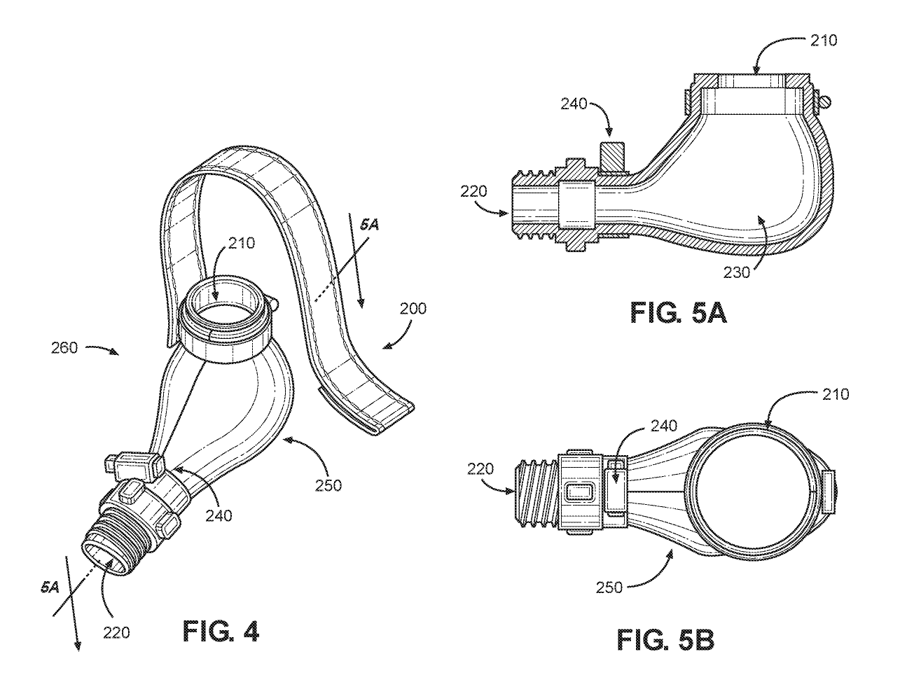

Referring now to FIGS. 4, 5A and 5B there are shown a perspective view, a cross-sectional view along line 5A, and a top view respectively of an embodiment of a faucet adaptor from a water-aided plunger assembly. In the illustrated embodiment, the first aperture 210 is shaped and proportioned to receive and to secure a range of differently sized and differently shaped faucet heads, to facilitate hassle free operation of the device. Furthermore, a rotatable clamp 270 disposed on the outer surface of the faucet adaptor 200 is configured to create a vacuum seal around a faucet head within the space provided by an open interior volume 230 when the faucet head is inserted through the first aperture 210. Additionally, a fastener 260 is disposed on the exterior surface of the first aperture 210, such that the fastener can be looped around the inserted faucet head to further secure the faucet adaptor 200 to the intended faucet and maintain the integrity of the vacuum seal. In this embodiment the fastener 260 is of the hook and loop variety and is attached to the side of the faucet adapter 200 by an adhesive to keep production costs low. In other embodiments the fastener can take on the form of a belt buckle sewn directly onto the faucet adapter 200 to provide a stronger connection when securing a faucet within the faucet adapter 200.

After inserting the faucet head into the first aperture 210, securing it with fastener 260, and allowing water to pour into the vacuum sealed interior volume 230, the funnel shaped outer wall 250 will direct waterflow towards a second aperture 220, which in turn is connected to the first end 310 of the tubular hose 300 to provide waterflow to the plunger handle 100. The increased amount of water contained in the interior volume 230 and the narrowing of the funnel shaped outer wall 250 increase the amount of pressure exerted on the water as it passes through the second aperture 220. In on embodiment, an adjustable valve 240 is operably connected to the interior volume, such that it can further modulate the outgoing water pressure. This adjustable pressure function can increase the force exerted on the accumulated waste matter causing the blockage, and aid in the removal of said blockage.

Furthermore, the valve 270 is also configured be used to stop water flow completely in lieu of using the control mechanism of the faucet. This substitute control function of the valve 270 can be useful in instances where the control mechanism provided with the faucet being used is not functioning properly, or is inconveniently positioned such that having to turn the water off interfered with the process of removing the blockage.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A water-aided plunger assembly comprising:
a faucet adaptor having an open interior volume, a first aperture, a second aperture, and a funnel shaped outer wall configured to direct waterflow and increase water pressure;
the second aperture is disposed in the bottom end of the faucet adaptor and configured to be removably attached to the first end of a tubular hose;
the tubular hose having a first end configured to be removably attached to the faucet adapter, and a second end configured to be removably attached to a plunger handle;
the plunger handle having a first end, a second end, and a rigid cylindrical structure with a hollow channel to facilitate passage of waterflow therethrough;
wherein the first end of the handle is configured to be removably attached to the tubular hose, and the second end is configured to be removably attached to a plunger head;
the plunger head having a hollow interior cavity, such that an aperture is disposed on the top end of the dome and configured to secure the plunger handle in place without impeding access to the hollow interior cavity and the bottom end of the dome includes a circular shaped opening configured to create a vacuum seal upon making contact with a surface.

2) The water-aided plunger assembly of claim 1, wherein the first aperture is disposed on the top end of the adaptor and configured to receive and secure a faucet head, such that upon insertion the faucet head is vacuum sealed within the open interior volume.

3) The water-aided plunger assembly of claim 1, wherein a rotatable clamp disposed on the outer surface of the faucet adaptor is configured to create a vacuum seal around the faucet head within the space provided by the open interior volume.

4) The water-aided plunger assembly of claim 1, wherein a fastener is disposed on the exterior surface of the first aperture, such that the fastener can be looped around the inserted faucet head to further secure the faucet adaptor and maintain the integrity of the vacuum seal.

5) The water-aided plunger assembly of claim 1, wherein an adjustable valve is operably connected to the interior volume, and configured to modulate the outgoing water pressure such that it can further can increase the force exerted on the accumulated waste matter causing the blockage, and aid in the removal of said blockage.

6) The water-aided plunger assembly of claim 1, wherein the adjustable valve further configured be used to stop water flow completely in lieu of using the control mechanism of the faucet. This substitute control function of the valve 270 can be useful in instances where the control mechanism provided with the faucet being used is not functioning properly, or is inconveniently positioned such that having to turn the water off interfered with the process of removing the blockage.

7) The water-aided plunger assembly of claim 1, wherein the first aperture is shaped and proportioned to receive and to secure faucet heads of differing size and shape.

8) The water-aided plunger assembly of claim 1, wherein the plunger head is dome shaped.

9) The water-aided plunger assembly of claim 1, wherein the fastener is a hook and loop fastener.
